(19) United States
(12) Patent Application Publication
(10) Pub. No.: US 2004/0027831 A1
(43) Pub. Date: Feb. 12, 2004

(54) Stage light

(76) Inventor: Po-Yang Huang, Taipei (TW)

Correspondence Address: PRO-TECHTOR INTERNATIONAL, 20775 Norada Court, Saratoga, CA, 95070-3018, US

(21) Appl. No.: 10/214,074

(22) Filed: Aug. 6, 2002

(51) Int. Cl. F21V 3/00

(52) U.S. Cl. 362/363

(57) ABSTRACT

A stage light is constructed to include a lamp holder shell adapted for connecting to a lamp socket, a lampshade with color filter lenses suspended from the lamp holder shell, a bracket suspended from a stem in the lamp holder shell to hold a lamp inside the lampshade, and an actuator mounted in the bracket and adapted for rotating the lampshade relative to the lamp when the lamp turned on.

### BACKGROUND OF THE INVENTION

1. Field of the Invention:

The present invention relates to a stage light and, more particularly, to a small-scale stage light that can be directly installed in a lamp socket.

2. Description of the Related Art:

A variety of stage lights are known. These stage lights produce a colorful lighting effect when operated. However, regular stage lights are commonly heavy, bulky, and expensive, not economic for home use. There are also known small-scale stage lights suitable for home use. However, the installation of these small-scale stage lights requires special technique. Further, when a stage light installed, the power cord of the stage light must be well arranged and kept away from passageways. Leaving the power cord of the stage light disorderly exposed to the outside is dangerous to people playing around or passing by.

### SUMMARY OF THE INVENTION

The present invention has been accomplished under the circumstances in view. It is one object of the present invention to provide a stage light, which can directly be installed in a lamp socket so that the installation of the stage light is easy. It is another object of the present invention to provide a stage light, which is practical for home use. It is still another object of the present invention to provide a stage light, which is safe in use. It is still another object of the present invention to provide a stage light, which is compact and highly mobile. According to one aspect of the present invention, the stage light comprises a lamp holder shell adapted for connecting to a lamp socket, a lampshade suspended from the lamp holder shell, a bracket suspended from a stem in the lamp holder shell to hold a lamp inside the lampshade, and an actuator mounted in the bracket and adapted for rotating the lampshade relative to the lamp when the lamp turned on. According to another aspect of the present invention, the lampshade has color filter lenses formed integral with the periphery thereof for producing a colorful lighting effect when the lamp turned on. According to another aspect of the present invention, a voice controller is installed in the lamp holder shell, and adapted for controlling the light intensity of the lamp and the revolving speed of the actuator subject to the intensity of external voice.

### BRIEF DESCRIPTION OF THE DRAWINGS

FIG. 1 is an elevational view of a stage light according to the present invention.

FIG. 2 is an exploded view of the stage light according to the present invention.

FIG. 3 is a sectional side view of the stage light according to the present invention.

### DETAILED DESCRIPTION OF THE PREFERRED EMBODIMENT

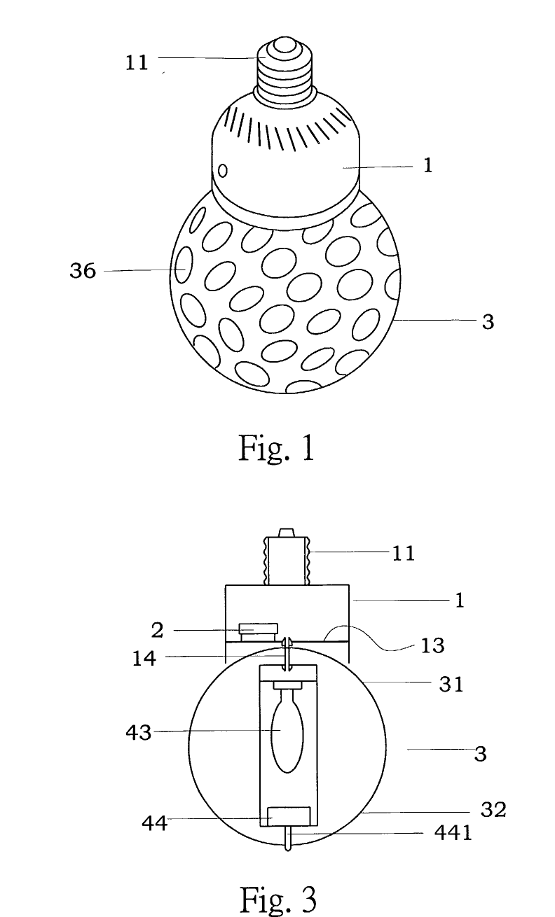

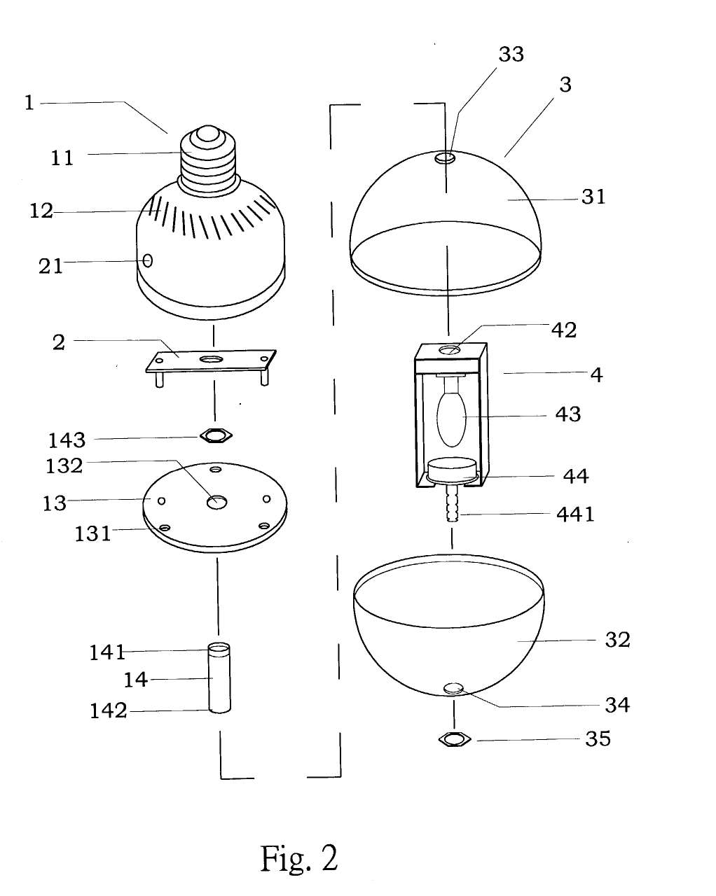

Referring to FIGS. 1 and 2, a stage light in accordance with the present invention is shown comprised of a lamp holder shell 1, a voice controller 2, a lampshade 3, and a lamp assembly 4. When electrically connected to a lamp socket (not shown), the lamp assembly 4 drives the lampshade 3 to rotate and at the same time emits light through the rotating lampshade 3, producing a lighting effect.

The lamp holder shell 1 comprises a base (same as the base of a lamp bulb having a ring contact and a tip contact) 11 adapted for connecting to a lamp socket, and a plurality of air vents 12 arranged around the periphery for quick dissipation of heat. A mounting plate 13 is fixedly fastened to the inside of the lamp holder shell 1. The mounting plate 13 has a plurality of mounting holes 131 respectively fixedly fastened to the lamp holder shell 1 by fastening elements, for example, screws (not shown), and a center through hole 132. A tubular stem 14 is provided having a first threaded end 151 inserted through the center through hole 132 and secured thereto by a lock nut 143 and a second threaded end 142 connected to the lamp assembly 4.

The voice controller 2 is mounted on the mounting plate 2 inside the lamp holder shell 1, having a switch 21 disposed outside the lamp holder shell 1 for switching on/off the voice controller 2. When the voice controller 2 switched on, the intensity of external voice controls the voice controller 2 to drive the lamp assembly 4.

The lampshade 3 is a hollow spherical shell comprised of a semispherical upper half shell 31 and a semispherical lower half shell 32. The upper half shell 31 has a center through hole 33 for the passing of the tubular stem 14. The lower half shell 32 has a center through hole 34. The upper half shell 31 and lower half shell 32 of the lampshade 3 have lenses 36 formed integral with the respective peripheral wall through which light passes from the lamp assembly 4 to the outside of the lampshade 3, producing a colorful lighting effect. According to this embodiment, the lenses 36 are color filter lenses.

The lamp assembly 4 is suspended from the stem 14 inside the lampshade 3, comprised of a bracket 41, a light-emitting element (a bulb or light emitting diode) 43, and an actuator, for example, a motor 44. The bracket 41 has a top mounting hole 42 fastened to the second threaded end 142 of the tubular stem 14. The light emitting element 43 is mounted inside the bracket 41, and controlled to emit light through the color filter lenses 36 to the outside of the stage light. The motor 44 is mounted in the bottom side of the bracket 41, having a threaded output shaft 441 fastened to the center through hole 34 of the lower half shell 32 of the lampshade 3 by a locknut 35.

Referring to FIG. 3 and FIG. 2 again, when the switch 21 switched on, electricity is connected to the voice controller 2, the light emitting element 43 and the motor 44. At this time, the voice controller 2 receives external voice, and controls the intensity of light of the light-emitting element 43 and the revolving speed of the motor 44. When the motor 44 started, the lampshade 3 is rotated with the output shaft 441 of the motor 44 relative to the lamp assembly 4.

Further, a control circuit may be installed and driven by the switch 21 to control the operation mode of the light-emitting element 43.

A prototype of stage light has been constructed with the features of FIGS. 1˜3. The stage light functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A stage light comprising:
a lamp holder shell, said lamp holder shell comprising a base;
a mounting plate fixedly fastened to said lamp holder shell, said mounting plate having a center through hole;
a tubular stem, said tubular stem having a threaded top end fixedly fastened to the center through hole of said mounting plate inside said lamp holder shell and a threaded bottom end;
a lamp assembly suspended from said tubular stem, said lamp assembly comprising a bracket fixedly fastened to the threaded bottom end of said tubular stem, and a light emitting element mounted in said bracket;
an actuator mounted in said bracket of said lamp assembly, said actuator having an output shaft; and
a hollow spherical lampshade formed of a semispherical upper half shell and a semispherical lower half shell and fixedly fastened to the output shaft of said actuator around said lamp assembly, said hollow spherical lampshade comprising a plurality of lenses formed integral the periphery thereof for the passing of light from said light emitting element, said semispherical upper half shell having a center through hole for the passing of said tubular stem, said semispherical lower half shell having a center through hole fixedly fastened to the output shaft of said actuator for turning with the output shaft of said actuator relative to said lamp assembly upon operation of said actuator.

2. The stage light as claimed in claim 1, wherein the base of said lamp holder shell has a threaded base adapted for electrically connecting to a lamp socket.

3. The stage light as claimed in claim 1, wherein said lamp bolder shell has a plurality of air vents arranged around the periphery thereof.

4. The stage light as claimed in claim 1, wherein said mounting plate comprises a plurality of mounting holes respectively fastened to said lamp holder shell by fastening means.

5. The stage light as claimed in claim 1, wherein the top and bottom ends of said tubular stem are threaded.

6. The stage light as claimed in claim 1, wherein said lenses of said lampshade are color filter lenses.

7. The stage light as claimed in claim 1, wherein said light emitting element is a light emitting diode.

8. The stage light as claimed in claim 1, wherein said light emitting element is a lamp bulb.

9. The stage light as claimed in claim 1, wherein said actuator is a motor.

10. The stage light as claimed in claim 1 further comprising a voice controller mounted inside said lamp holder shell and adapted for controlling the operation of said light emitting element and said actuator by means of voice, said voice controller having an on/off switch disposed outside said lamp holder shell.

11. The stage light as claimed in claim 10, wherein said voice controller comprising a control circuit adapted for controlling lighting mode of said light emitting diode.
